(19) United States
(12) Patent Application Publication
(10) Pub. No.: US 2025/0376210 A1
(43) Pub. Date: Dec. 11, 2025

(54) STEERING COLUMN FOR A MOTOR VEHICLE AND ASSEMBLY METHOD

(71) Applicant: ZF Active Safety GmbH, Koblenz (DE)

(72) Inventors: Lars EHRMANN, Köln (DE); Goriun GRIGORIANS SOHRULI, Meerbusch (DE); Ram Prasad MUSUNURU, Neuss (DE)

(21) Appl. No.: 19/230,193

(22) Filed: Jun. 6, 2025

(30) Foreign Application Priority Data
Jun. 7, 2024 (DE) 10 2024 205 259.0

(51) Int. Cl. B62D 1/183; B62D 1/19

(52) U.S. Cl. CPC B62D 1/183; B62D 1/192

(57) ABSTRACT

The present invention relates to a steering column (100) for a motor vehicle with an inner tube (2) and a support part (1) surrounding the inner tube (2), which are coupled to one another in a rotationally fixed manner and are translationally adjustable relative to one another, wherein a linear bearing (12) and a pressure piece (7) are provided between the inner tube (2) and the support part (1). The pressure piece (7) is deformed into the elastic-plastic range during assembly and remains in the steering column (100) under plastic deformation. Furthermore, the invention relates to an assembly method for a steering column (100).

### TECHNICAL FIELD

The present invention relates to a steering column for motor vehicles, in particular with a steer-by-wire steering system, which comprises the steering column according to the invention. Furthermore, the invention relates to an assembly method for a steering column.

### BACKGROUND

Motor vehicles usually have a steering handle by means of which a driver can influence the direction of travel of a motor vehicle. For this purpose, the steering handle is mechanically connected to the steered wheels via a steering shaft and a rack. In order to adjust the steering handle to different body sizes and comfort requirements, it has an adjustment device by means of which the steering handle can be moved at an angle relative to the vehicle as well as in a translational manner.

(Partially) autonomous vehicles are motor vehicles that participate in road traffic in frequently occurring driving situations without human input on the steering handle or pedals. The normal case for an autonomous vehicle is that the driver does not have to pay attention to the road traffic, but can pursue other activities. In such a scenario, there is no need for the driver to control the vehicle. In particular, motor vehicles with steer-by-wire steering systems, which do not require mechanical access to the wheel-positioning steering gear, allow further degrees of freedom with regard to the spatial movement of a steering handle.

In some situations, however, it may be necessary for the driver to intervene and steer the vehicle using the steering handle. For example, in a situation where the autonomous vehicle cannot correctly assess the traffic situation. In such a case, it is necessary for the driver to be able to take control of the vehicle as quickly as possible.

The vehicle must therefore be designed to provide the driver with the pedals and a steering handle as quickly and reliably as possible. During autonomous operation, the steering handle and pedals are preferably folded away from the driver to provide the greatest possible freedom of movement. If the steering handle is to be made available to the driver at a specific time, it must be possible to transfer the steering handle to the driver with a high degree of safety and within a short time.

For example, during autonomous driving, the steering handle can be lowered into the vehicle interior. From this lowered position, the steering handle must be moved directly and in a technically absolutely reliable manner towards the driver, in particular by a distance of more than 20 cm, preferably between 20 cm and 40 cm.

Telescopic steering columns have proven to be a proven technology in the prior art, providing a rigid connection between the vehicle and the steering handle. Here, a support part is attached to the motor vehicle and an inner tube with the steering handle is movably mounted to this effect. The inner tube is arranged in a rotationally fixed manner relative to the support element, wherein multiple inner tubes and support elements can also be telescopically moved into one another.

In order for the support part and the inner tube to be able to move translationally relative to each other with as little play as possible, the bearing between these components must be as free from play as possible. Different manufacturing tolerances of the steering column components and different expansion coefficients make it difficult for the inner tube to extend during operation. In particular, the tolerances between the support part and the inner tube are not constant along the extension path, but vary due to manufacturing. In order to minimize tolerances between the inner tube and the support part, pressure pieces have proven to be effective. These are arranged between a linear bearing and the support part or inner tube.

Different pressure pieces are known to press the linear bearing against the support part or the inner tube. For example, DE 10 2022 109 598 A1 shows a bearing arrangement of a steering column housing for a motor vehicle with a rotatably mounted steering shaft and an outer housing and an inner housing. The outer housing is arranged to be displaceable relative to the inner housing, with a linear bearing being provided for easy displacement. The rolling elements of the linear bearing are pressed onto the inner housing by means of a spring arrangement.

DE 601 08 561 T2 discloses a linear sliding guide module with balls for transmitting a load-bearing force between two parts without relative play. It is provided that a rolling element can roll on a roller rail, wherein the roller rail is coupled to a first shaft with an elastomer. The elastomer is elastically deformed during assembly and generates a compressive force on the roller rail and thus on the rolling element. This preload force minimizes the play between the rolling element and an outer tube.

### SUMMARY

It is an object of the present invention to overcome the disadvantages of the prior art, in particular to provide a steering column which ensures a high availability of the steering handle in an emergency mode.

This object is achieved according to the invention by a steering column for a motor vehicle with an inner tube and a support part surrounding the inner tube, wherein the inner tube and the support part are coupled to one another in a rotationally fixed manner and are translationally adjustable relative to one another, and at least one linear bearing is arranged between the inner tube and the support part, and a pressure piece is arranged between the linear bearing and the inner tube or between the linear bearing and the support part, wherein the pressure piece is elastically-plastically deformed in an assembled state.

The support part is firmly coupled to the vehicle, and the inner tube can be partially accommodated in the support part and is connected to it via a linear bearing. A steering handle is attached to the inner tube, which handle is moved towards the driver by means of a translational movement. A steer-by-wire system does not provide a mechanical connection between the steering handle and the steered wheels of the vehicle, which is why no steering shaft needs to be guided through the inner tube. A steering torque feedback unit may act on the steering shaft to haptically communicate to the driver a steering torque applied to the vehicle wheels, wherein the steering torque feedback unit may be arranged within the steering column.

A pull-out resistance between the support part and the inner tube should be avoided, which is why a linear bearing is provided which can comprise rolling elements. The linear bearing supports the inner tube relative to the support part and reduces unwanted yielding of the steering handle during operation

It is intended that a pressure piece is arranged between the linear bearing and the inner tube or between the linear bearing and the support part. The pressure piece is used to press the linear bearing against the support part or the inner tube in order to reduce play in the steering column. The pressure piece is designed to compensate for manufacturing-related tolerances and/or to equalize different thermal expansion coefficients. Preferably, the steering column has three linear bearings, wherein at least one linear bearing is equipped with a pressure piece according to the invention. The pressure piece has an elastic property and presses the linear bearing against the inner tube and support element, thereby reducing the play in the steering column.

According to the invention, the pressure piece is elastically-plastically deformed in an assembled state. Accordingly, the pressure piece was elastically plastically deformed during assembly starting from a pre-assembly state in order to provide the properties of an elastically plastically deformed component in the assembled state. If the pressure piece were only elastically deformed during assembly, a tolerance chain that was too large could result in play between the support part and the inner tube. A tolerance chain sums up the individual tolerances of adjacent components. If the outer dimension of the inner tube is at the outer tolerance limit, i.e. slightly smaller than the target dimension, and the support part is also at the outer tolerance limit and therefore slightly larger than the target dimension, the gap to be bridged by the pressure piece is larger than calculated. If, for example, the distance between the inner tube and the linear bearing is unusually large due to the tolerances and the pressure piece has only be slightly plastically deformed, it is possible that the pressure piece would only exert a small clamping force on the linear bearing or the inner tube due to the small deformation.

Tight tolerances and high bearing forces within the steering column require only a small elastic deformation of the pressure piece. It must therefore be ensured that the pressure piece can provide its full elastic deformation in the assembled state, regardless of an excessively large tolerance chain.

This is achieved by elastically-plastically deforming the pressure piece in an assembled state. If the distance between the inner tube and the support part is particularly large due to manufacturing tolerances, an elastic clamping force is still guaranteed. At such a point, the pressure piece would only be slightly plastically deformed and would retain the entire elastic clamping force. If the clearance between the support part and the inner tube is particularly tight due to manufacturing tolerances, the pressure piece would be plastically deformed more in this part than in another place. Even at this point, the entire elastic clamping force would still be available. Since the pressure piece is only intended for one-time assembly, the plastic deformation is not detrimental. Regardless of how much the pressure piece is plastically deformed, it retains its elastic property by means of which the linear bearing is pressed against the inner tube or the support part.

Different materials are suitable for use as pressure pieces, with metallic materials with a pronounced yield strength being preferred. With these materials, the transition from elastic to plastic material behavior can be easily controlled, which is why the preload can be easily adjusted during assembly.

The material used results in a conflict of objectives, as the steering column and thus also the pressure piece must be as rigid as possible in order to shift the natural vibrations into an acceptable range. On the other hand, there must be sufficient clearance between the components to create a large tolerance compensation range for the pressure piece. If a high preload is to be ensured, the material must be highly compressed and can therefore no longer cover a large tolerance range. If, on the other hand, a large tolerance range is covered, the force on this section is lower.

Stress-strain diagrams show the ratio of force to displacement and the elastic clamping force for different materials. This clamping force is used to press the linear bearing against the inner tube or the support part.

According to a first aspect of the invention, it is provided that the linear bearing has two roller rails and that one roller rail is arranged on the inner tube and the support part, wherein the pressure piece is arranged between the roller rail and the inner tube or between the roller rail and the support part. According to this aspect, a linear bearing is provided which has rolling elements that roll on two roller rails. Here, one of the roller rails is arranged on the support part and one on the inner tube. The pressure piece is provided between one of these roller rails and the support part or inner tube.

However, it is conceivable that the pressure piece is arranged between both roller rails and the corresponding support part and/or inner tube. This allows a larger tolerance compensation range to be provided, as two pressure pieces act on one linear bearing.

The roller rail on the inner tube and/or on the support part can be part of the linear bearing and it is intended that the rolling elements of the linear bearing roll directly on the roller rail. Furthermore, the linear bearing can comprise a rolling element cage that spaces the rolling elements apart from one another.

According to any one embodiment, the pressure piece applies an elastic clamping force to the linear bearing when assembled. The deformation of the pressure piece creates an elastic force by means of which the tolerances can be compensated. Due to unfavorable constellations of tolerances, it can happen that the pressure piece is not plastically deformed in certain regions, but only elastically. In such a region, only elastic clamping forces are present, without any plastic deformation occurring during assembly. Different manufacturing tolerances between the inner tube and the support part can occur along an extraction direction of the inner tube.

A further advantageous embodiment provides that the pressure piece applies an elastic clamping force to the roller rail over its entire length. Due to the large displacement distances of the inner tube relative to the support part, the roller rail must be supported along the entire length. If the pressure piece only generated a clamping force at individual points on the roller rail, the roller rail would bend. The pressure piece is therefore intended to support the roller rail with a clamping force along its entire length in order to be able to compensate for the tolerances between the two components at different points.

Preferably, the steering column has a pressure piece which includes contact sections by means of which the pressure piece can be brought into contact with the roller rail and the inner tube or the support part. Via these contact sections, the pressure piece can provide the elastic clamping force along the entire length of the roller rail. The distance between the contact sections along the extension direction can be constant or have different distances. Preferably, the distance between the contact sections in an overlapping region between the inner tube and the support part is smaller in the extended state than in the overlapping region in the retracted state. This allows a very stiff steering handle to be achieved when extended.

According to any one design, the pressure piece meanders between the roller rail and the inner tube and provides spring elasticity. In this embodiment, the pressure piece is designed as a corrugated spring, which has several contact sections by means of which the roller rail can be connected to the support part or the inner tube. The valleys and peaks of the meandering wave spring form the contact sections.

Preferably, the steering column has a pressure piece that is deformed to a predetermined yield limit during assembly of the linear bearing. Depending on the material used for the pressure piece, a different yield limit must be maintained to avoid the material being deformed beyond its yield strength. The stress-strain relationship varies between different materials and must be taken into account for assembly. The ratio of elastic to plastic deformation depends on the material and can be adapted to the tolerances to be compensated.

Preferably, the pressure piece is deformed to the 0.2% yield limit. The pressure piece can also be deformed up to the 3% yield limit, preferably up to a maximum of 80% of the yield strength. Alternatively, deformation can occur beyond the yield strength, as the pressure piece is not only deformed under tension, but also under compression. Regardless of how much the pressure piece is plastically deformed, an elastic clamping force remains unchanged, which is why materials with a pronounced yield strength are advantageous.

According to any one design, the pressure piece is deformed to the maximum yield strength during assembly of the linear bearing. If the pressure piece is deformed beyond this yield strength, it will break or may lose its elastic clamping force.

Preferably, the steering column has three roller rails, with the pressure piece being arranged between the roller rail and the inner tube. Each of the roller rails can have a pressure piece, but one pressure piece is sufficient for a certain arrangement of the linear arrangement. More than three roller rails can also be used and offer the advantage of providing additional stiffening of the steering column.

Preferably, the pressure piece is made of a metallic material and has a wave-shaped two-dimensional profile. The two-dimensional profile results from a side view relative to the extension direction and shows a pressure piece that meanders between the roller rail and the support part or inner tube.

According to a further aspect of the invention, the roller rail has a higher surface hardness than the inner tube and/or the support part. A higher surface hardness helps to prevent the rolling elements from working into the support part or the inner tube and thus wearing out faster.

It can be provided that the steering column comprises multiple support components and several inner tubes which can be moved telescopically into one another. Here, a first inner tube is surrounded by a second inner tube. The second inner tube can be surrounded by the support part or by another inner tube. In other words, the support part can have multiple inner tubes, wherein the components are connected to each other via several roller rails and linear bearings. Each of the roller rails or at least each of the linear bearings can have a pressure piece according to the invention.

Preferably, the roller rail has a surface coating on the side facing the pressure piece, wherein the surface coating has a noise-damping property. In order to reduce noise emissions, an additional damping layer is provided to avoid frictional vibrations and reduce the generation of sound waves. This damping layer can be applied as a surface coating to the roller rail and ensures noise decoupling from the movable parts of the steering column to the support part.

According to a preferred embodiment, the inner tube and the support part each have an end region at their two ends, wherein an intermediate region is provided between two end regions. It is intended that a rolling bearing gap between the roller rails is smaller in the end regions than in the intermediate region. Thus, the distance between the roller rails changes and is larger in an intermediate region than in the two end regions. This ensures that the rolling elements and an associated rolling element cage are mostly located in the intermediate region. This arrangement prevents the rolling elements from staying in the end regions due to vibrations and rolling friction conditions and jamming when the steering column is moved or from moving against an end stop, which then requires a higher displacement force (cage creep). Due to the tighter fit in the end regions, the rolling elements are forced to stay in the intermediate region.

The expanding pressure piece noticeably increases the preload between the inner tube and the support part, since the linear bearing arrangement is under higher tension and thus the natural frequency of the steering column is advantageously increased. The improved vibration behavior and the play-free movement of the steering column increase the driver's sense of comfort.

Furthermore, the object of the invention is achieved by an assembly method for a steering column, wherein the pressure piece is elastically-plastically deformed during assembly.

### BRIEF DESCRIPTION OF THE DRAWINGS

Further features, advantages and properties of the invention are explained on the basis of the description of preferred embodiments of the invention with reference to the figures, wherein:

FIG. 1 shows an embodiment of a steering column according to the invention in a view transverse to an extension direction;

FIG. 2 shows the steering column according to FIG. 1 in a sectional view along the extension direction;

FIG. 3 shows a section of the steering column according to FIG. 2, and

FIG. 4 shows a schematic stress-strain diagram of a pressure piece according to the invention.

### DESCRIPTION

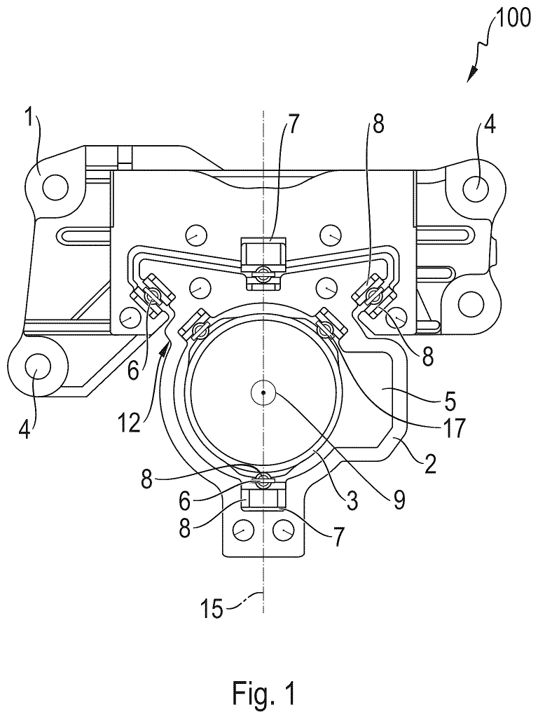

FIG. 1 shows an embodiment of a steering column according to the invention in a view transverse to an extension direction. The steering column 100 comprises a support part 1 and an inner tube 2, wherein the support part 1 is fixedly attached to a vehicle by means of the fastening holes 4. Furthermore, the support part 1 accommodates a pressure piece 7 and roller rails 8 in recesses provided for this purpose. Rolling elements 6 roll on the roller rails 8, which rolling elements are connected to the inner tube 2 via another pair of guide rails 8.

The inner tube 2 is translationally displaced by means of the linear bearings 12 along an extension direction 9, which lies in the viewing direction. The inner tube 2 has a recess 5 into which a crash system can be installed, which dissipates the impact energy of a motor vehicle driver in the event of a crash and reduces injuries.

On the inside of the inner tube 2, further roller rails 8 and a further pressure piece 7′ are arranged, on which rolling elements 6 roll, which are connected to a further inner tube 3. The nesting of support part 1, inner tube 2 and further inner tube 3 enables a telescopic function of the steering column 100 and the rolling elements 6 located between the components allow them to be easily moved relative to one another.

The pressure pieces 7, 7′ are mounted between the support part 1 and the inner tube 2 or between the first inner tube 2 and the second inner tube 3 in such a way that they compensate for manufacturing tolerances. Depending on the actual design of the steering column 100, several pressure pieces 7 can be provided for each linear bearing arrangement 12. It is conceivable that the pressure piece 7 is mounted on a roller rail 8 other than the one shown.

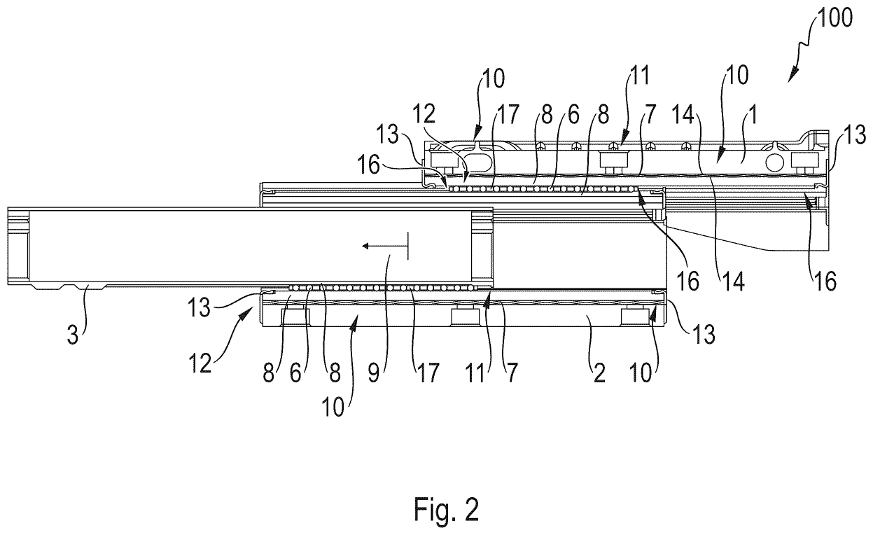

FIG. 2 shows the steering column 100 from FIG. 1 in a longitudinal section, wherein the extension direction 9 shows that the inner tube 2 and the further inner tube 3 are mounted so as to be displaceable to the right and left in the plane of the drawing. In the position shown, the steering column 100 is in a partially extended position. The support part 1 is connected to a motor vehicle (not shown) and is mounted in a stationary manner, while the inner tube 2 and the further inner tube 3 roll on the linear bearing arrangement 12 and are mounted displaceably. Between a roller rail 8 of the support part 1 and/or the inner tube 2, a pressure piece 7 is arranged, which in this embodiment is designed as a corrugated spring.

The pressure piece 7 meanders between the roller rail 8 and the support part 1 and provides a clamping force over the entire extension length 9. To prevent the pressure piece 7 from falling out of the support part 1, two end caps 13 are provided which fix the pressure piece 7 in place. If the pressure piece 7 has multiple contact regions 14, a uniform force is produced for the roller rail 8, by means of which the rolling elements 6 are pressed onto the opposite roller rail 8.

In the sectional view shown, the inner tube 2 also has a pressure piece 7, by means of which a rolling element 6 is pressed against the further inner tube 3. Similar to the first linear bearing arrangement 12, it can be provided here that the inner tube 2 has end caps 13 by means of which the pressure piece 7 is fixed.

If the further inner tube 3 is moved along the extension direction 9, the two linear bearings 13 preferably move uniformly and without play relative to each other, whereby the steering handle (not shown) can be made available to the motor vehicle driver with as little play as possible. If the steering column 100 expands to varying degrees due to temperature differences, the pressure pieces 7 can absorb this deformation and ensure a uniform pressure of the linear bearing 13 against the inner tube 2 and/or the further inner tube 3.

The support part 1 and/or the inner tube 2 can have end regions 10 and intermediate regions 11. The end regions 10 are located at the respective ends of the support part 1 or the inner tube 2. An intermediate region is provided between the end regions 10. A rolling bearing gap 16 is larger in the intermediate region 11 than in the end regions 10. The rolling bearing gap 16 is the region which results between the roller rails 8 for the rolling elements 6. Due to the limited rolling element gap 16 in the end regions 10, the rolling elements 6 and an associated rolling element cage 17 are displaced into the intermediate region 11.

If the steering column 100 is in a state for autonomous driving, the rolling element cage 17 and the rolling elements 6 are located in the intermediate region 11. If the motor vehicle experiences impacts, the rolling element cage 17 does not move into the end regions 10 because the rolling bearing gap 16 is narrower there than in the intermediate region 11. If the rolling element cage 17 were to move into the end regions 10 and a displacement of the inner tube 2 and the further inner tube 3 were then necessary, the rolling element cage 17 could jam and require a higher displacement force. In such a scenario, the rolling elements 6 no longer roll but slide, with the sliding friction being higher than the rolling friction. This displacement force could be so high that displacement is not possible. The end regions 10 and the intermediate region 11 therefore ensure greater availability of the steering handle, as the steering column cannot become jammed.

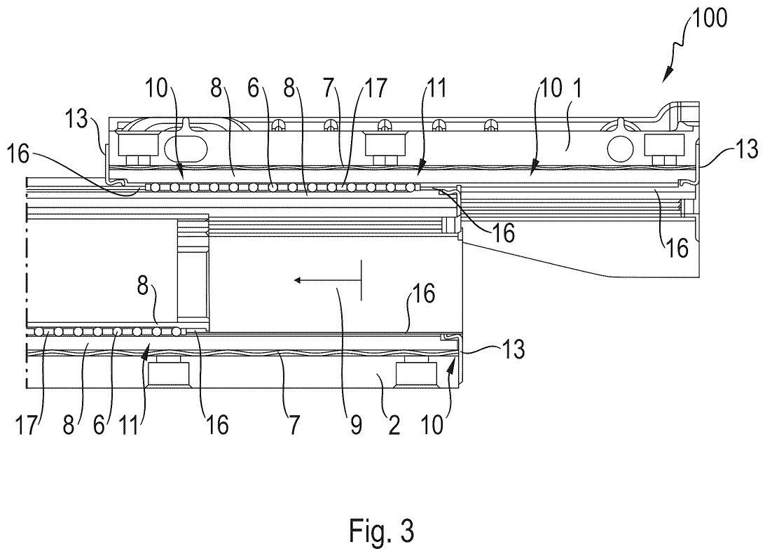

FIG. 3 shows a section of the steering column according to FIG. 2, with similar components being provided with the same reference numerals. This illustration clearly shows the wave structure of the pressure piece 7, by means of which a force is transmitted to the roller rail 8, which in turn presses the rolling elements 6 against the roller rail 8 fastened to the inner tube 2. This prevents play in the steering column 100 and ensures a rigid connection between the inner tube 2 and the support part 1.

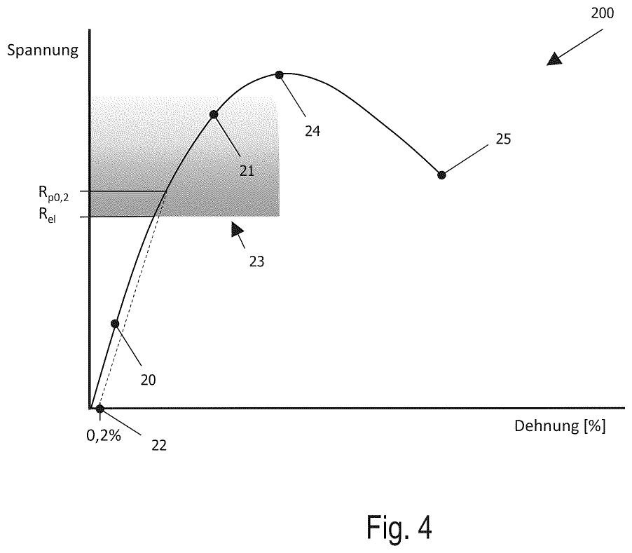

FIG. 4 shows a schematic stress-strain diagram 200 of a pressure piece 7 according to the invention according to FIGS. 1 to 3. The strain is plotted in percent on the abscissa and the corresponding stress on the ordinate. In an elastic range 20 the material deforms elastically and there is no plastic deformation. If the pressure piece 7 is deformed into the elastic range 20 by an external force, it bends back to its original state after the force is removed without any plastic deformation remaining.

If the pressure piece 7 is deformed beyond the elastic limit Rel, a plastic deformation remains after the external force is removed. For example, if the material is deformed to the 0.2% yield strength Rp0.2, a (plastic) strain of 0.2% 22 remains. The material has therefore been plastically deformed, but still retains elastic tension, as can be seen from the dashed line. If the pressure piece 7 is further deformed into the plastic range 21, the plastic strain that remains after the removal of the external force increases. In any case, however, the material retains an elastic force, regardless of how much it has been plastically deformed. When the material reaches tensile stress 24, the stress decreases until the material fails at fracture 25.

According to the invention, the pressure piece 7 is deformed through the elastic range 20 into the plastic range 21 during assembly and remains assembled in such a state. Preferably, the material is deformed to the 0.2% yield strength 22 during assembly. This offers advantages in the case of different tolerance chains between the support part 1 and the inner tube 2 or between the two roller rails 8, which are connected to the support part 1 and the inner tube 2 and lead to different rolling bearing gaps 16. The advantages are explained in more detail below using different tolerances.

In a first scenario, the rolling bearing gap 16 is larger than calculated due to an unfavorable tolerance chain. Based on the calculated rolling bearing gap 16, a corresponding preload of the pressure piece 7 is selected, which leads to a 0.2% yield strength 22. However, since the rolling bearing gap 16 is larger than calculated due to the tolerance chain, the rolling element cage is not deformed to the 0.2% yield strength in the installed state, but deforms to a lesser extent. In this state, the material can still be plastically deformed, albeit less than the 0.2% yield strength. In this installed state, the pressure piece 7 still has the entire elastic range 20 available to compensate for the tolerance, since the pressure piece 7 only loses some plastic deformation.

If the material were to be deformed only up to the elastic limit Rel, as is known in the prior art, a lower clamping force would result due to the larger rolling element gap, since the pressure piece 7 has to apply a certain part of the elastic range 20 to overcome the excessive tolerance.

In another scenario, the rolling element gap 16 is smaller than calculated due to the tolerance chain. In this scenario, the pressure piece is deformed beyond the 0.2% yield strength 22 because the smaller distance in the rolling bearing gap 16 causes the pressure piece 7 to deform more than calculated. However, this is not a problem because the tolerance chain creates a rolling bearing gap that is large enough to prevent the pressure piece from compressing to tensile stress. In this scenario, the pressure piece 7 is deformed further into the plastic range than calculated, which does not lead to any functional impairment. Despite the greater plastic deformation, the pressure piece 7 still has the entire elastic range 20 available to compensate for manufacturing tolerances or to equalize different expansion coefficients.

The plastic range 21 therefore serves as a buffer for an unfavorable tolerance chain with respect to the rolling bearing gap 16. If preload is applied to the plastic range 21 during assembly, an excessively large rolling element gap can lead to a decrease in the plastic strain. However, if a rolling bearing gap 16 is smaller than calculated, the plastic component of the deformation increases. However, this is not harmful to the pressure piece, as it can provide an elastic clamping force even if it is plastically deformed. The deformation into the plastic range 21 also has the advantage that the entire elastic range 20 can always be used to compensate for tolerances.

If the pressure piece 7 were to be preloaded only in the elastic range 20, then in the case of a larger rolling bearing gap than calculated, part of the elastic deformation would be required to fill the rolling bearing gap and there would be a lower clamping force available to clamp the inner tube 2 and the support part 1 against each other. The manufacturing tolerances can therefore be larger than before when using the pressure piece 7 according to the invention, which can significantly reduce the manufacturing costs.

A plastic deformation of the pressure piece 7 is not disadvantageous for the steering column 100, since the pressure piece 7 is designed for single use only.

If necessary, isolated features can be selected from the combinations of features disclosed here and used in combination with other features to define the subject matter of the claim, dissolving any structural and/or functional connection that may exist between the features. The order and/or number of steps of the methods can be varied.

### REFERENCE NUMERALS

1 support part
2 additional inner tube
3 inner tube
4 fastening hole
5 recess
6 rolling elements
7 pressure piece
8 roller rails
9 extension direction
10 end region
11 intermediate region
12 linear bearing
13 end cap
14 contact sections
15 section plane
16 rolling bearing gap
17 rolling element cage
20 elastic range
21 plastic range
22 0.2% yield strength
23 assembled condition
24 tensile stress
25 fracture
100 steering column
200 stress-strain diagram

1. A steering column (100) for a motor vehicle, comprising an inner tube (3) and a support part (1) surrounding the inner tube (3), wherein the inner tube (3) and the support part (1) are coupled to one another in a rotationally fixed manner and are translationally adjustable relative to one another, and at least one linear bearing (12) is arranged between the inner tube (3) and the support part (1), wherein a pressure piece (7) is arranged between the linear bearing (12) and the inner tube (3) or between the linear bearing (12) and the support part (1), wherein the pressure piece (7) is elastically-plastically deformed.

2. The steering column (100) for a motor vehicle according to claim 1, wherein the pressure piece (7) is present in a pre-assembled state and in an assembled state, wherein the pressure piece (7) is elastically-plastically deformed during the transition from the pre-assembled to the assembled state.

3. The steering column (100) for a motor vehicle according to claim 1, wherein a roller rail (8) is arranged on the inner tube (2) and/or on the support part (1), on which rail the linear bearing (12) rolls, wherein the pressure piece (7) is arranged between the roller rail (8) and the inner tube (2) or between the roller rail (8) and the support part (1).

4. The steering column (100) for a motor vehicle according to claim 1, wherein the pressure piece (7) is elastically-plastically deformed in the assembled state in such a way that it applies an elastic clamping force to the linear bearing (12), wherein the pressure piece (7) provides an elastic clamping force in particular over the entire translationally adjustable length.

5. The steering column (100) for a motor vehicle according to claim 1, wherein the pressure piece (7) has contact sections (14) via which the pressure piece (7) applies the elastic clamping force to the linear bearing (12).

6. The steering column (100) for a motor vehicle according to claim 1, wherein a distance between the contact sections (14) along an extension direction (9) is constant or has different distances, in particular the distance between the contact sections (14) in an overlap region between the inner tube (2) and the support part (1) is smaller in an extended state than in an overlap region in a retracted state.

7. The steering column (100) for a motor vehicle according to claim 1, wherein the pressure piece (7) meanders along the extension direction (9) between the roller rail (8) and the inner tube (2) or between the roller rail (8) and the support part (1) and/or provides a spring elasticity.

8. The steering column (100) for a motor vehicle according to claim 1, wherein the pressure piece (7) has punches and/or beads which are dimensioned such that they are elastically-plastically deformed during assembly of the pressure piece and generate an elastic clamping force.

9. The steering column (100) for a motor vehicle according to claim 1, wherein the pressure piece (7) is plastically deformed during assembly depending on a tolerance chain.

10. The steering column (100) for a motor vehicle according to claim 1, wherein the pressure piece (7) is deformed beyond the yield strength (24) when the linear bearing (12) is mounted.

11. The steering column (100) for a motor vehicle according to claim 1, wherein the pressure piece (7) is arranged between the roller rail (8) and the inner tube (2) and the inner tube (2) has at least two roller rails (8) and one pressure piece (7).

12. The steering column (100) for a motor vehicle according to claim 1, wherein the pressure piece (7) is made of a metallic material and has a wave-shaped two-dimensional profile along the extension direction (9).

13. The steering column for a motor vehicle according to any one claim 1, wherein the roller rail (8) has a surface hardness equal to or higher than that of the inner tube (2) and/or support part (1).

14. The steering column (100) for a motor vehicle according to claim 1, wherein the inner tube (2) and the support part (1) each have an end region (10) at their two extension ends, and an intermediate region (11) is provided between two end regions (10), wherein a rolling bearing gap (16) between the roller rails (8) is smaller in the end regions (10) than in the intermediate region (11).

15. The steering column (100) for a motor vehicle according to claim 1, wherein the steering column (100) has at least two inner tubes (2) and a support element (1) which are telescopic relative to one another.

16. An assembly method, in particular for a steering column (100) according to claim 1, in which an inner tube (3) and a support part (1) are coupled to one another in a rotationally fixed manner and in a translationally adjustable manner relative to one another, wherein at least one linear bearing (12) is arranged between the inner tube (3) and the support part (1), and wherein a pressure piece (7) is mounted between the linear bearing (12) and the inner tube (3) or between the linear bearing (12) and the support part (1), wherein the pressure piece (7) is elastically-plastically deformed during assembly.
